(19) United States
(12) Patent Application Publication
(10) Pub. No.: US 2011/0304868 A1
(43) Pub. Date: Dec. 15, 2011

(54) INKJET PRINTER, INKJET HEAD, AND PRINTING METHOD

(75) Inventor: Masaru Ohnishi, Nagano (JP)

(73) Assignee: Mimaki Engineering Co., Ltd., Nagano (JP)

(21) Appl. No.: 13/203,242

(22) PCT Filed: Feb. 27, 2009
(86) PCT No.: PCT/JP2009/053694

§ 371 Date: Aug. 25, 2011

(51) Int. Cl. G06K 15/02

(52) U.S. Cl. 358/1.9

(57) ABSTRACT

To appropriately suppress an impact of an air resistance encountered by ink droplets discharged from nozzles of an inkjet head.

In an inkjet printer, an inkjet head (12) includes nozzles (104) and an air blowing unit (120). The air blowing unit (120) includes a primary-airflow blowing port (108) that generates a primary airflow directed towards a printing medium (50) along the ink droplets discharged from the nozzles (104), and a secondary-airflow blowing port (110) that generates a secondary airflow that is directed towards the printing medium (50) along the ink droplets on either side of the primary airflow.

### TECHNICAL FIELD

The present invention relates to an inkjet printer, an inkjet head, and a printing method.

### BACKGROUND ART

Inkjet printers that perform printing by discharging ink droplets from a nozzle are widely in use. In recent years, there has been a need for further reduction in a size of an ink droplet in response to the growing demand for a higher printing precision in inkjet printers. For example, with the growing versatility of inkjet printers, there is also a growing need to widen a distance (gap length) between an inkjet head and a printing medium.

### DISCLOSURE OF INVENTION

### Problem to be Solved by the Invention

A kinetic energy of a flying droplet is proportional to its mass. The mass of the droplet in turn is proportional to a cube of its radius r (r3). The radius refers, for example, to the radius when a shape of the droplet is approximated to sphere.

An air resistance that the flying droplet encounters in the air includes a component that is proportional to the radius r and a component that is proportional to a square of the radius r (r2). Therefore, overall, the air resistance is proportional to a value between r and r2. Due to the relation between the kinetic energy and the air resistance, as the droplet size decreases, the impact of the air resistance becomes more prominent during the flight of the droplet through the air.

Therefore, it is necessary to appropriately suppress an impact of an air resistance to appropriately reduce the size of the ink droplet. For example, when the gap length is longer, a longer time is taken by the ink droplets to encounter the air resistance, therefore, it is necessary to appropriately suppress the impact of the air resistance.

In view of the above discussion, the inventor of the present application first thought of assisting the flight of an ink by generating an airflow around the flying ink droplets. After a diligent research the inventor found that the flight of the ink cannot be assisted properly by merely generating the airflow. For example, the inventor found that if a speed of the airflow is increased to further reduce the impact of the air resistance, turbulence is generated in the airflow and the flight of the ink droplets cannot be assisted properly. Therefore, it is desirable to use more appropriate method for suppressing the impact of the air resistance. It is an object of the present invention to provide an inkjet printer, an inkjet head, and a printing method that can solve the problem described above.

While searching for prior art related to the present invention, Patent Document 1 and Patent Document 2 were found. Patent Document 1 relates to a bump forming device that injects an inert gas and discharges a molten solder from a nozzle. Patent Document 2 relates to an inkjet recording device that utilizes an airflow and an electrostatic force. However, the structures described in these patent documents are for providing solutions to completely different problems than that addressed by the present invention. The structures in the patent documents are also very different from that of the present invention.
Patent Document 1: Japanese Patent Application Laid-open No. 2000-294591
Patent Document 2: Japanese Patent Application Laid-open No. H8-238766

### Means for Solving Problem

The present invention has the following structure for providing a solution to the problem described above.

(Structure 1) An inkjet printer comprises an inkjet head that discharges an ink droplet towards a printing medium. The inkjet head includes a nozzle that discharges the ink droplet towards the printing medium, and an air blowing unit that generates an airflow towards the printing medium along the ink droplet discharged from the nozzle. The air blowing unit includes a primary-airflow blowing port that generates a primary airflow that is directed towards the printing medium along the ink droplet discharged from the nozzle, and a secondary-airflow blowing port that generates a secondary airflow that is directed towards the printing medium along the ink droplet on either side of the primary airflow.

The primary airflow is, for example, in direct contact with the ink droplets and is directed towards the printing medium. The secondary airflow is, for example, directed towards the printing medium along the ink droplets at a position that is at a greater distance from the ink droplets than a distance from the ink droplets to the primary airflow.

The secondary-airflow blowing port, for example, aids the primary airflow by blowing the secondary airflow along the primary airflow, thereby suppressing spreading or a slow down of the primary airflow. Moreover, the secondary-airflow blowing port maintains a streamlined primary airflow by blowing such a secondary airflow. When the primary airflow is functioning independently without the aid of the secondary airflow, the speed thereof may be the speed that produces turbulence. The primary-airflow blowing port and the secondary-airflow blowing port are connected to a blower, for example, with their respective pipes, and blow their respective airflows generated by the blower.

With this structure, the ink droplets are caused to fly in the airflow that is directed from the nozzles towards the printing medium. As a result, a relative speed of the ink droplets with respect to the surrounding air is less than in the case when no airflow is blown. Furthermore, consequently, an impact of the air resistance on the ink droplets also reduces.

In this case, a streamlined primary airflow is maintained by further blowing the secondary airflow along the primary airflow, in addition to the primary airflow flowing along the ink droplets, thereby being able to stabilize the primary airflow. The speed of the primary airflow can be further increased with a structure in which it is easy to streamline the primary airflow. Thus, with such a structure, the impact of the air resistance encountered by the ink droplets can be appropriately supressed.

Furthermore, by suppressing the impact of the air resistance, the ink droplets can be made to properly reach the printing medium even when, for example, a size of the ink droplets has been reduced. Thus, the size of ink droplets can be appropriately reduced. The inkjet head can discharge the ink droplets having a size (volume) of, for example, 1 picoliter (pl) or less (for example, 0.1 pl to 1 pl).

Moreover, by suppressing the impact of the air resistance, a flight distance of the ink can be increased without the ink forming a mist. Consequently, even if a distance (gap length) between the inkjet head and the printing medium is more, printing can be performed properly. Thus, with such a structure, the distance (gap length) between the inkjet head and the printing medium can be increased. As a result, an inkjet printer with a large gap length can be suitably provided.

For example, when the size (volume) of the ink droplets is 3 pl (for example, 2.5 pl to 3.5 pl), the gap length can be, for example, 10 millimeter (mm) or more (for example, 10 mm to 100 mm). The gap length can be, for example, 100 mm or more.

(Structure 2) The nozzle is formed on a nozzle surface that faces the printing medium in the inkjet head. The primary-airflow blowing port is formed at a position that is adjacent to the nozzle on the nozzle surface. The secondary-airflow blowing port is formed at a position that is adjacent to the nozzle on either side of the primary-airflow blowing port on the nozzle surface. With such a structure, the primary airflow and the secondary airflow can be appropriately blown.

(Structure 3) The inkjet head includes a plurality of the nozzles arranged in a row as a nozzle row on the nozzle surface. The primary-airflow blowing port that is provided in a first area that is adjacent to the nozzle row on the nozzle surface, and that extends along a direction of the nozzle row, and that blows from the first area a slit-shaped primary airflow on either side of the nozzle row. The secondary-airflow blowing port that is provided in a second area that is adjacent to the first area on the nozzle surface, and that extends along a direction of the nozzle row, and that blows from the second area a slit-shaped secondary airflow towards the printing medium along the primary airflow.

In the inkjet printers, a printing speed is improved by having a plurality of the nozzles simultaneously discharging the ink droplets. However, if the airflow along the ink droplets is generated individually for every nozzle, it will result in a substantial increase in the cost. Furthermore, increased gap will be required between the nozzles, resulting in a problem for printing in a high resolution.

In contrast, due to this structure, the primary airflow and the secondary airflow can be appropriately generated common to a plurality of the nozzles in a nozzle row, without either a substantial increase in the cost or decrease in the printing resolution. Furthermore, due to this, the impact of the air resistance encountered by the ink droplets can be further suppressed.

(Structure 4) The secondary-airflow blowing port blows the secondary airflow at a speed that is 0.3 to 1.2 times the speed of the primary airflow. Due to this structure, the secondary airflow can appropriately aid the primary airflow. The speed of the secondary airflow should preferably be 0.8 to 1.2 times the speed of the primary airflow.

In the structure 4, the speed of the primary airflow and the speed of the secondary airflow are respective initial speeds. The initial speed of the primary airflow is the speed of the primary airflow immediately after it is blown from the primary-airflow blowing port. Similarly, the initial speed of the secondary airflow is the speed of the secondary airflow immediately after it is blown from the secondary-airflow blowing port.

The very existence of the secondary airflow has the advantage of aiding the primary airflow. However, for the secondary airflow to aid the primary airflow more appropriately, it is preferable that the speed thereof be substantially equal to or slightly less than the speed of the primary airflow. Furthermore, the primary airflow and the secondary airflow slow down in the time period until they reach the printing medium. The secondary airflow that is more outward than the primary airflow slows down even more than the primary airflow. As a result, even if the initial speed of the secondary airflow is slightly slower, there is a reversal at the time the secondary airflow reaches the printing medium, and the speed of the secondary airflow becomes nearly equal to that of the primary airflow. Thus, by setting the speed of the secondary airflow as stated above, the advantage of the secondary airflow can be further improved.

The preferred relation between the speeds of the primary airflow and the secondary airflow will change according to their respective positions, and their distances from the nozzle. Therefore, the relation between the speeds of the primary airflow and the secondary airflow should be suitably adjusted, for example, from the range given above, according to the structure of the inkjet head.

The air blowing unit can include one primary-airflow blowing port and a plurality of the secondary-airflow blowing ports that is arranged at varying distances from the primary-airflow blowing port. In such a case, it is preferable to set the speed of at least the secondary airflow that is blown from the secondary-airflow blowing port arranged closest to the primary-airflow as stated above. Furthermore, it is preferable that the speed of the secondary signal flow blown from the secondary-airflow blowing port that is closer to the primary-airflow blowing port be closer to the speed of the primary airflow. The speed of the secondary airflow that is more outward should preferably be slower than the speed of the primary airflow. Due to this structure, the secondary airflow can aid the primary airflow more appropriately, and the primary airflow can be more appropriately streamlined.

(Structure 5) The inkjet head discharges the ink droplet from the nozzle at an initial speed that is such that a speed of the ink droplet at a time of deposition on the printing medium is higher than a speed of the main airflow at a time the airflow reaches the printing medium.

At a time of deposition on the printing medium, if the speed of the ink droplet relative to the primary airflow is 0, a deposition accuracy of the ink droplet can be adversely influenced if turbulence occurs in the airflow. In contrast, due to this structure, the relative speed of the ink droplet directed towards the printing medium can be positively maintained even at the time of deposition, and the ink droplet can be deposited with a greater accuracy.

Accordingly, with such a structure, the impact of the air resistance encountered by the ink droplets can be more appropriately suppressed. Furthermore, if the speed of the ink droplet at the time of deposition of the ink droplet on the printing medium is v1, and a speed (flow speed) of the primary airflow around the ink droplet is v2, then the speed v1 should preferably be 1.1 to 5 times the speed v2.

Furthermore, when the effect of the turbulence in the airflow is small at the time of deposition, the speed v1 can be made 1.1 times the speed v2 or less. A wider range of speed can be set as the speed v1. For example, the speed v1 can also be set to 0.5 to 5 times the speed v2. More preferably, the speed v1 can be set 0.8 to 5 times the speed v2.

(Structure 6) The inkjet printer includes an ink storage unit that stores therein the ink to be discharged from the nozzle; and a pressure adjusting unit that adjusts an ambient pressure of the ink storage unit. The pressure adjusting unit adjusts the ambient pressure of the ink storage unit by relaying a blowing pressure of the main airflow from the primary-airflow blowing port to the ink storage unit.

To appropriately achieve the advantages of generation of the airflow, it is sometimes necessary to increase the speed of the airflow. For example, to form a stably streamlined airflow (primary airflow), the speed thereof needs to be increased. In such a case, the pressure of the airflow near the nozzle can become a positive pressure, leading to a reverse flow of the airflow from the nozzle into the inkjet head.

In contrast, due to this structure, the pressure inside the inkjet head is appropriately adjusted according to, for example, the air blowing pressure. Therefore, due to this structure, the pressures inside of and outside of the inkjet head can be appropriately maintained at steady levels. Thus, for example, air can be prevented from going from the nozzle into the inkjet head. Furthermore, for example, the ink can also be appropriately prevented from leaking out of the inkjet head from the nozzles.

The ink storage unit is an intermediate tank that is provided in an area on an ink supplying side inside the inkjet head or in between in an ink supply channel to the inkjet head. The pressure adjusting unit is a pipe that is connected to the ink storage unit. The pipe is branched at a point between the blower that generates the airflow (primary airflow) and the blowing port of the airflow.

Due to this structure, even if the pressure of the blower varies, the variation in the pressures inside of and outside of the inkjet head, which is connected via the nozzle, is cancelled out. Thus, due to this structure, the pressures inside of and outside of the inkjet head can be maintained at steady levels.

(Structure 7) An inkjet head that discharges an ink droplet towards a printing medium and includes a nozzle that discharges the ink droplet towards the printing medium; and an air blowing unit that generates an airflow directed towards the printing medium along the ink droplet that is discharged from the nozzle. The air blowing unit includes a primary-airflow blowing port that generates a primary airflow that is directed towards the printing medium along the ink droplet discharged from the nozzle, and a secondary-airflow blowing port that generates a secondary airflow that is directed towards the printing medium along the ink droplet on either side of the primary airflow. When performed in this manner, the same advantages as, for example, Structure 1 can be achieved.

(Structure 8) A printing method for printing by an inkjet method by discharging an ink droplet towards a printing medium includes discharging the ink droplet from a nozzle towards the printing medium; and blowing from an air blowing unit an airflow directed towards the printing medium along the ink droplet discharged from the nozzle. The airflow directed towards the printing medium includes a primary airflow that is directed towards the printing medium along the ink droplet discharged from the nozzle, and a secondary airflow that is directed towards the printing medium along the ink droplet on either side of the primary airflow. When performed in this manner, the same advantages as, for example, Structure 1 can be achieved.

### ADVANTAGES OF THE INVENTION

According to the present invention, an impact of an air resistance encountered by ink droplets that are discharged from a nozzle of an inkjet head can be appropriately suppressed.

### BRIEF DESCRIPTION OF DRAWINGS

FIG. 1 is an example of a structure of an inkjet printer 10 according to an embodiment of the present invention.

FIG. 2 is a modelized representation of ink droplets discharged from a nozzle of an inkjet head where (a) in FIG. 2 is an example of a case in which printing is performed when the ink droplets reach a printing medium 50, and (b) in FIG. 2 is an example of a case when a gap length Lg is longer.

FIG. 3 is a more detailed drawing of an example of the structure of an inkjet head 12.

FIG. 4 is more detailed drawing of a first example of a structure of the inkjet head 12 where (a) in FIG. 4 is a cross-sectional view of the inkjet head 12, and (b) in FIG. 4 is a drawing of the inkjet head 12 viewed from underside (nozzle surface).

FIG. 5 is a more detailed drawing of a second example of a structure of the inkjet head 12 where (a) in FIG. 5 is a cross-sectional view of the inkjet head 12, and (b) in FIG. 5 is a drawing of the inkjet head 12 viewed from underside (nozzle surface).

### BEST MODE(S) FOR CARRYING OUT THE INVENTION

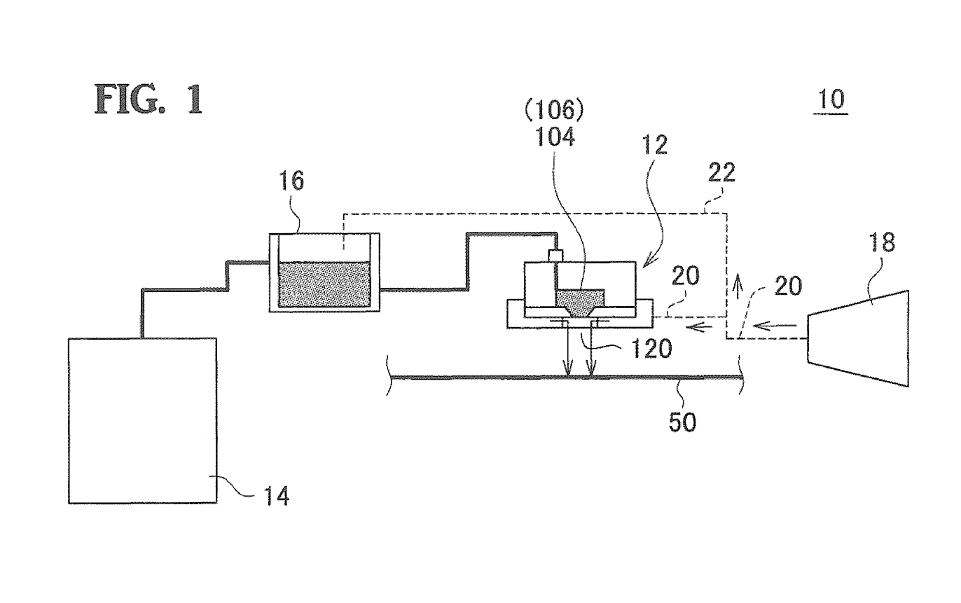

Exemplary embodiments of the present invention are explained below with reference to the accompanying drawings. FIG. 1 is an example of a structure of an inkjet printer 10 according to an embodiment of the present invention. The inkjet printer 10 is a printing apparatus that prints on a printing medium 50 by an inkjet method. The inkjet printer 10 includes an inkjet head 12, an ink bottle 14, an intermediate ink tank 16, a blower 18, an airflow supply pipe 20, and an airflow branch pipe 22.

In the present embodiment, the inkjet printer 10 is a printing device that performs printing by a multi pass method, and causes the inkjet head 12 to perform a scanning movement whereby the inkjet head 12 moves while discharging ink droplets. For this purpose, the inkjet printer 10 further includes, for example, a not shown head driving mechanism for moving the inkjet head 12, a not shown transport mechanism for transporting the printing medium 50, etc.

The inkjet head 12 is a print head that includes nozzles 104 for discharging the ink droplets. In the present embodiment, the inkjet head 12 includes a plurality of the nozzles 104 arranged in a row as a nozzle row 106 on a nozzle surface that faces the printing medium 50. An air blowing unit 120 surrounds the nozzle row 106. The air blowing unit 120 blows an airflow along the ink droplets discharged from the nozzles 104, directing the ink droplets towards the printing medium 50. In the present embodiment, because of the airflow, the inkjet head 12 lends assistance in the flight of the ink droplets. A structure for blowing the airflow and an advantage thereof will be explained in detail later.

The ink bottle 14 is a bottle that stores therein an ink for use in the inkjet printer 10. The intermediate ink tank 16 is a tank that stores therein the ink in between in an ink channel that connects the ink bottle 14 to the inkjet head 12. The intermediate ink tank 16 stores therein the ink received from the ink bottle 14, and supplies the ink to the inkjet head 12 as the printing operation progresses. In the present embodiment, the intermediate ink tank 16 functions as an ink storage unit that stores therein the ink prior to its discharge from the nozzles 104. As a modification of the present invention, a region on an ink supplying side inside the inkjet head 12 or the ink bottle 14, etc., can be used as the ink storage unit.

In the present embodiment, the inkjet printer 10 performs printing using all colors of YMCK inks. The inkjet printer 10 can perform printing using inks other than the YMCK inks. The inkjet printer 10 can include a separate ink bottle 14 and a separate intermediate ink tank 16 for the ink of each color.

The blower 18 is an airflow generating device that generates an airflow. The airflow generated by the blower 18 is supplied to the inkjet head 12 via the airflow supply pipe 20. The airflow generated by the blower 18 is blown into the inkjet head 12 through the air blowing unit 120.

The airflow supply pipe 20 is a pipe that connects the blower 18 to the inkjet head 12, and supplies the airflow generated by the blower 18 to the inkjet head 12. The airflow branch pipe 22 is a pipe that branches off from the airflow supply pipe 20. Because the airflow branch pipe 22 is connected to the intermediate ink tank 16, the blower 18 and the intermediate ink tank 16 are interconnected.

With this structure, the airflow branch pipe 22 relays an air blowing pressure that is the same as that in the air blowing unit 120 provided in the inkjet head 12 to the intermediate ink tank 16 that is the ink storage unit. Thus, the airflow branch pipe 22 functions as a pressure adjusting unit that adjusts an ambient pressure of the ink storage unit.

To appropriately achieve the advantages of generation of the airflow, it is sometimes necessary to increase a speed of the airflow. In such a case, the pressure of the airflow near the nozzles 104 is set to a positive pressure, which leads to a reverse flow of the airflow from the nozzles 104 into the inkjet head 12.

In contrast, in the present embodiment, the pressure inside the inkjet head 12 is appropriately adjusted according to, for example, the air blowing pressure. Therefore, the pressures inside of and outside of the inkjet head 12 can be appropriately maintained at steady levels. Thus, for example, air can be prevented from going from the nozzles 104 into the inkjet head 12. Furthermore, for example, the ink can also be appropriately prevented from leaking out of the inkjet head 12 from the nozzles 104.

Furthermore, in the present embodiment, for example, even if the pressure of the blower 18 fluctuates, the fluctuations in the pressures inside of and outside of the inkjet head 12, which is connected via the nozzles 104, is cancelled out. Thus, in the present embodiment, for example, the pressures inside of and outside of the inkjet head 12 can be appropriately maintained at steady levels.

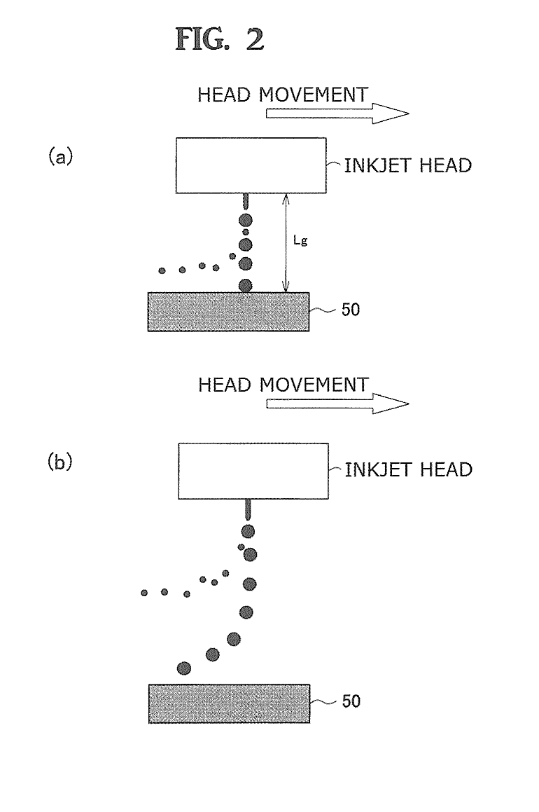

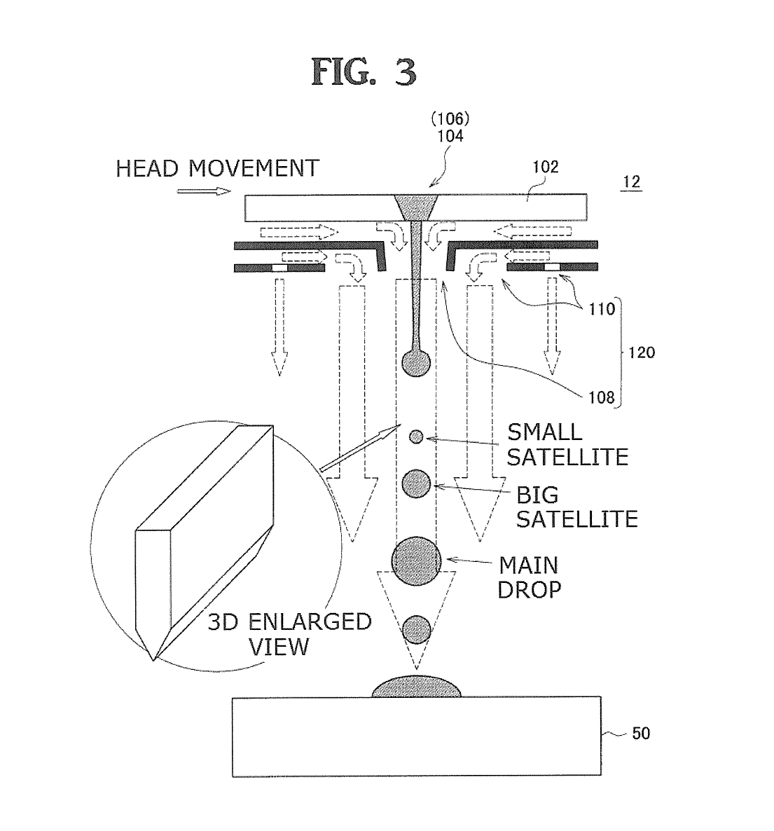

FIG. 2 and FIG. 3 are drawings of examples of the structure for blowing the airflow, and the advantage thereof. In FIG. 2, the ink droplets discharged from the nozzles of the inkjet head are shown as a modelized representation of the flight of the ink droplet when no airflow is being blown.

(a) in FIG. 2 is an example of a case in which printing is performed when the ink droplets reach the printing medium 50. The ink droplets discharged from the nozzle of the inkjet head encounter the air resistance, and fly towards the printing medium 50. Furthermore, if a gap length Lg that is the distance between the inkjet head and the printing medium 50 is reduced to counter the impact of the air resistance, as shown in (a) in FIG. 2, the ink droplets deposit on the printing medium 50.

In the inkjet method, when the ink is discharged, apart from a main droplet (main drop) having a size that is preset according to deposition accuracy required based on the printing precision, there are often droplets, called satellites, that are smaller than the main drop. The satellites, being smaller in mass and lower in kinetic energy, are more easily influenced by an air resistance than the main drop. Consequently, the satellites are slowed down more quickly than the main drops, thus easily forming a mist without reaching the printing medium 50.

When the satellites form the mist, the misted ink tends to adhere to the internal parts of the printer or to the printing medium 50, leading to staining of the internal parts of the printer or quality degradation of the printing medium 50. Thus, to perform proper printing with inkjet printers, it is preferable to give attention to formation of mist of the satellites.

(b) in FIG. 2 is an example of a case when the gap length Lg is longer. When the gap length Lg is longer, as shown in (b) in FIG. 2, even the main drop becomes a mist because of the greater impact of the air resistance on the ink droplet until it reaches the printing medium 50. As a result, the ink droplets do not reach the printing medium 50 and printing cannot be done properly.

Therefore, it is necessary to set the gap length Lg such that the main drop reaches the printing medium 50. In the inkjet printer having the conventional structure in which the assistance is not lent by the airflow, when the YMCK ink having a droplet size of 3 pl is used, the gap length Lg should, for example, be 2 mm to 4 mm.

FIG. 3 is a more detailed drawing of the example of the structure of the inkjet head 12, and shows a structure in the vicinity of the nozzles 104 in a cross section of the inkjet head 12 that lies in a plane that is parallel to a discharge direction of the ink droplets. This cross section is perpendicular to a row direction of the nozzle row 106.

In the present embodiment, in the inkjet head 12, the nozzles 104 are formed on the nozzle surface that faces the printing medium 50. Furthermore, around the nozzles 104, the air blowing unit 120 includes a primary-airflow blowing port 108 and secondary-airflow blowing ports 110.

The primary-airflow blowing port 108 is a blowing port formed adjacent to the nozzle row 106 on the nozzle surface, and blows a primary airflow directed towards the printing medium 50 along the ink droplets discharged from the nozzles 104. Thus, the primary-airflow blowing port 108 blows the airflow that directly lends assistance in the flight of the ink droplets.

The secondary-airflow blowing ports 110 are blowing ports formed adjacent to the nozzle row 106 on either side of the primary-airflow blowing port 108 on the nozzle surface. The secondary-airflow blowing ports 110 blow a secondary airflow that is directed towards the printing medium 50 along the ink droplets on either side of the primary airflow. The secondary airflow is an airflow that is, for example, blown towards the printing medium 50 along the ink droplets at a position that is at a greater distance from the ink droplets than a distance from the ink droplets to the primary airflow and that controls the flow of the primary airflow by flowing along the primary airflow. By blowing the secondary airflow along the primary airflow, the secondary-airflow blowing port 110 guides the primary airflow even faster while maintaining a streamlined primary airflow. Thus, the secondary-airflow blowing ports 110 blow the airflow that lends assistance in the flight of the ink droplets indirectly via the primary airflow.

In the present embodiment, the secondary airflow blown from the secondary-airflow blowing port 110 is a somewhat smaller airflow than the primary airflow, but is blown at substantially the same speed as the primary airflow towards the printing medium 50. With this structure, a more streamlined primary airflow can be realized. The speed of the secondary airflow is preferably, for example, 0.3 to 1.2 times, or more preferably, 0.8 to 1.2 times the speed of the primary airflow. With this structure, the secondary airflow can aid the primary airflow more appropriately, and a more streamlined primary airflow can be realized.

Furthermore, in the present embodiment, to guide the streamlined primary airflow even faster, the air blowing unit 120 includes, for a single primary-airflow blowing port 108, a plurality of the secondary-airflow blowing ports 110 at varying distances from the primary-airflow blowing port 108. The secondary-airflow blowing port 110 that is closer to the primary-airflow blowing port 108 should preferably blow the secondary signal flow at a speed that is closer to that of the primary airflow. With this structure, a more streamlined primary airflow can be realized.

Furthermore, in the present embodiment, as shown in a 3D enlarged view in FIG. 3, the airflow blown from the primary-airflow blowing port 108 is a slit-shaped airflow, with a longer direction thereof being parallel to the nozzle row 106. The airflows blown from the secondary-airflow blowing ports 110 are slit-shaped and parallel to the primary airflow. Thus, the air blowing unit 120 forms slit-shaped airflows in the same direction as the discharge direction of the ink droplets, covering the entire nozzle row 106.

Furthermore, when the primary airflow is functioning independently without the aid of the secondary airflow, the speed thereof may be the speed that produces turbulence. The primary-airflow blowing port 108 and the secondary-airflow blowing ports 110 are connected to the blower 18 (see FIG. 1) with their respective airflow supply pipes 20. The airflow branch pipe 22 (see FIG. 1) that functions as a pressure adjusting unit, branches off from the airflow supply pipe 20 corresponding to the primary-airflow blowing port 108, relays the blowing pressure of the primary airflow from the primary-airflow blowing port 108 to the intermediate ink tank 16, and adjusts an ambient pressure of the intermediate ink tank 16.

How the ink droplets are discharged in the inkjet printer is explained next. As shown in FIG. 3, at a time of discharge of an ink droplet in the inkjet printer, a column of ink (ink column) that extends from the nozzles 104 is formed according to a discharge pressure that acts in the direction from inside the inkjet head 12 to outside the inkjet head 12. The ink forms into an ink droplet at the end of the ink column. When the ink droplet detaches itself from the ink column, it is discharged towards the printing medium 50 as an ink droplet. The discharged ink droplet travels towards the printing medium 50 at an initial speed determined by the discharge pressure.

Thereafter, the discharged ink droplet travels towards the printing medium 50 while encountering the air resistance. However, if there is a greater impact of the air resistance, the ink droplets form a mist while traveling towards the printing medium 50, and cannot properly reach the printing medium 50. Specifically, the ink droplets do not properly reach the printing medium 50 if the size of the ink droplets is small or the gap length is large.

Furthermore, as explained with reference to (a) in FIG. 2, during discharge of the ink droplets, apart from the main drop, satellites of various sizes that are smaller than the main drop are likely to form. These satellites are more susceptible to formation of mist as compared to the main drop, thus causing staining of the internal parts of the printer or quality degradation of the printing medium 50.

In contrast, in the present embodiment, the ink droplets are caused to fly in the airflow that is directed from the nozzles 104 towards the printing medium 50. As a result, a relative speed of the ink droplets with respect to the surrounding air is less than that in the case when no airflow is blown. When traveling towards the printing medium 50, the ink droplets encounter the air resistance that is determined by the relative speed in the surrounding air. As a result, given that the speed is the same in both the cases, the impact of the air resistance on the ink droplets traveling in the primary airflow is less than in the case when no airflow is blown.

Therefore, in the present embodiment, the ink droplets can be made to reach properly to the printing medium 50 even if the size of the ink droplets is small or the gap length is large. The size of the main drop can be set to, for example, 1 pl or less (for example, 0.1 pl to 1 pl). Furthermore, when the size of the ink droplets is 3 pl (for example, 2.5 pl to 3.5 pl), the gap length can be set to 10 mm or more (for example, 10 mm to 100 mm). It is possible to set the gap length, for example, to more than 100 mm.

Furthermore, in the present embodiment, even when the satellites are formed, formation of mist can be appropriately prevented by suppressing the impact of the air resistance. Furthermore, assisted by the airflow, even the small satellites tend to reach the printing medium more easily. Thus, according to the present embodiment, the problems occurring due to formation of mist of the satellites can be appropriately prevented from occurring.

Furthermore, according to the present embodiment, by generating the airflows at two levels, namely, the primary airflow and the secondary airflow, and allowing the secondary airflow to flow around the primary airflow, a more stably streamlined primary airflow is formed in the vicinity of the ink droplets. Consequently, the ink droplets can be deposited with a greater accuracy. Moreover, by further streamlining the primary airflow, the speed thereof can be increased further. Consequently, the impact of the air resistance on the ink droplets can be reduced further.

According to the present embodiment, as described above, the impact of the air resistance encountered by the ink droplets can be appropriately suppressed. Thus, printing can be appropriately performed with a high accuracy even if, for example, the size of the ink droplet is small or the gap length is large.

The ink droplet and the speed of the airflow in the present embodiment are explained next. In the present embodiment, the inkjet head 12 discharges the ink droplet from the nozzles 104 at an initial speed of v10 such that a speed v1 of the ink droplet at a time of deposition on the printing medium 50 is greater than a speed v2 of the primary airflow surrounding the ink droplet. The initial speed v10 of the ink droplet that has entered the primary airflow is accelerated to a speed obtained by adding a speed of the primary airflow to the initial speed v10.

The speed v1, for example, is the speed of the ink droplet at a time of deposition. The ink droplet has the same size as that of the main drop. Furthermore, the speed v2 is the speed of the primary airflow at a time the airflow reaches the printing medium 50. The air blowing unit 120 generates the primary airflow at an initial speed corresponding to the speed v2. It is preferable that the speed v1 be 0.8 to 5 times the speed v2.

When the speed v1 is equal to the speed v2, the relative speed of the two speeds becomes zero, and there is no impact of the air resistance. The ink droplet reaches the printing medium 50 even in this case. However, the ink droplet is influenced by the primary airflow at the time of deposition, and tends to be carried by the airflow. The condition v1−v2>0 is an essential determining factor for an accurate deposition position.

Upon reaching the printing medium 50, the primary airflow flows along the surface of the printing medium 50 in a direction away from the ink droplet. Consequently, turbulence in the airflow can easily occur near the printing medium 50. If the speed v1 is equal to the speed v2, the deposition position of the ink droplet can become inaccurate due to the turbulence, and the deposition accuracy can be affected.

In contrast, in the present embodiment, at the time of deposition too, the kinetic energy of the ink droplet can be maintained by positively maintaining the relative speed of the ink droplets directed towards the printing medium 50. Thus, the tiny ink droplet can be made to fly a greater distance with a high deposition accuracy.

In the time period until the ink droplet reaches the printing medium 50, the speed of the ink droplet varies according to a magnitude relation between the speed of the ink droplet and the speed of the primary airflow, the impact of the air resistance encountered by the ink droplet within the primary airflow, etc. If the speed of the ink droplet is greater than the speed of the primary airflow, the speed of the ink droplet slows down within the primary airflow. If the speed of the ink droplet is greater than the speed of the primary airflow, the ink droplet accelerates within the primary airflow.

Furthermore, when the effect of the turbulence in the airflow is small at the time of deposition, the speed v1 can be made 1.1 times the speed v2 or less. A wider range of speed can be set as the speed v1. For example, the speed v1 can also be set to 0.5 to 5 times the speed v2. More preferably, the speed v1 can be set 0.8 to 5 times the speed v2.

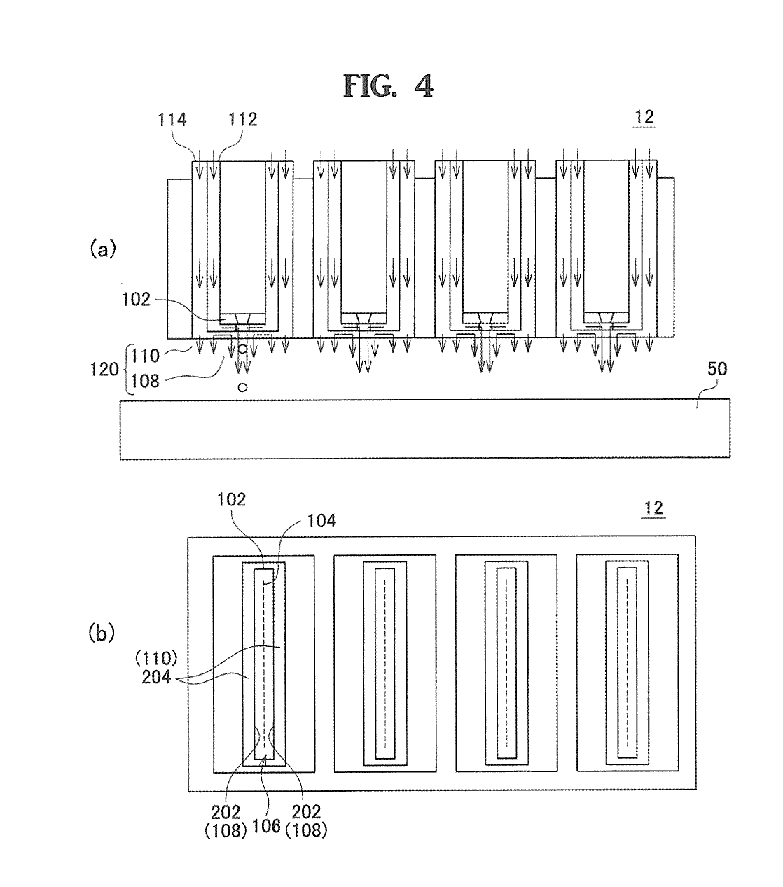

FIG. 4 is a more detailed drawing of a first example of a structure of the inkjet head 12. (a) in FIG. 4 is a cross-sectional view of the inkjet head 12 and (b) in FIG. 4 is a drawing of the inkjet head 12 viewed from underside (nozzle surface).

In the present embodiment, the inkjet head 12 has a structure in which single-color inkjet heads, each of which discharges the ink of one color among a plurality of colors being used, are integrated as a single unit. The inkjet head 12, for example, includes a single-color inkjet head for discharging the ink of each of the colors of the YMCK inks.

The inkjet head 12 can further include a single-color inkjet head that discharges, apart from the colors of the YMCK inks, for example, a special color ink. A structure described below can be applied to only the single-color inkjet head that discharges any of the YMCK inks or a specific special color ink.

Each single-color inkjet head includes a nozzle plate 102 with the nozzle row 106 formed thereon. Each single-color inkjet head includes the air blowing unit 120, a primary-airflow feed port 112, and a secondary-airflow feed port 114. The air blowing unit 120 includes the primary-airflow blowing port 108 and the secondary-airflow blowing ports 110 that are slit-shaped and that surround the nozzle row 3.

The primary-airflow blowing port 108 is provided in a first area 202 that is adjacent to the nozzle row 106. The primary-airflow blowing port 108 blows from the first area 202 a slit-shaped primary airflow on either side of the nozzle row 106. In the present embodiment, the first area 202 is an area that is, for example, adjacent to the nozzle row 106 on the nozzle surface, and that extends along a direction of the nozzle row 106.

Furthermore, the secondary-airflow blowing port 110 is provided in a second area 204 that is adjacent to the first area 202. The secondary-airflow blowing port 110 blows from the second area 204 a slit-shaped secondary airflow directed towards the printing medium 50 along the primary airflow. In the present embodiment, the second area 204 is an area that is, for example, adjacent to the first area 202 on the nozzle surface, and that extends along a direction of the nozzle row 106.

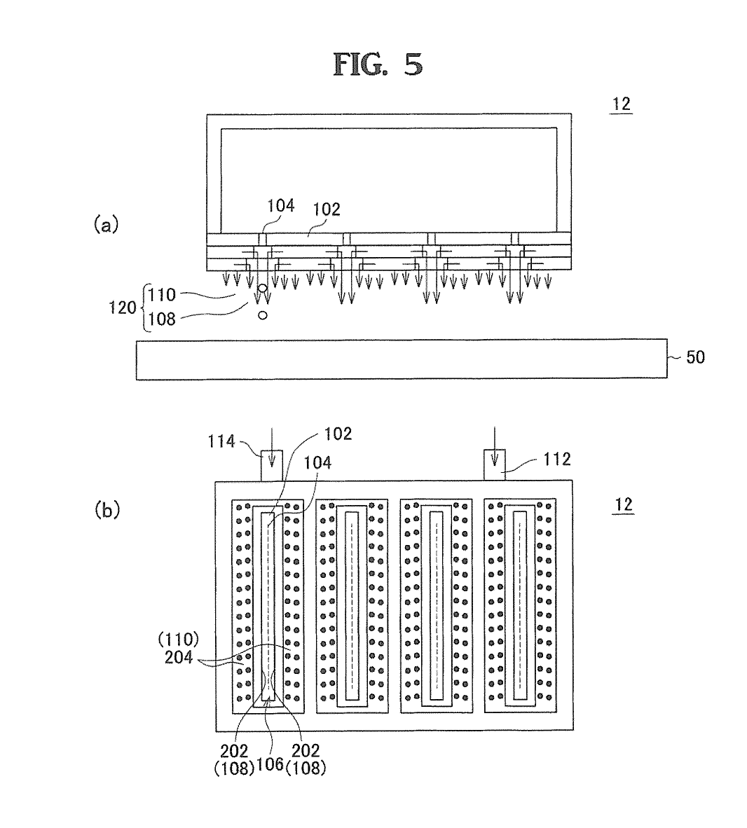

The primary-airflow feed port 112 is a feed port for the air blown as the primary airflow. The secondary-airflow feed port 114 is a feed port for the air blown as the secondary airflow. In the present embodiment, the primary-airflow feed port 112 and the secondary-airflow feed port 114 are connected to the blower 18 via the airflow supply pipe 20, and receive from the blower 18 air having a pressure according to the airflow blown from the primary-airflow blowing port 108 and the secondary-airflow blowing ports 110, respectively. Alternatively, the primary-airflow feed port 112 and the secondary-airflow feed port 114 each can be provided at one place in the inkjet head 12, common to all the nozzle rows 106, as in the example explained later with reference to FIG. 5.

According to the present embodiment, the primary airflow and the secondary airflow that assist the flight of the ink droplets are appropriately generated. Thus, the impact of the air resistance encountered by the ink droplets can be appropriately suppressed.

Furthermore, a high print resolution can be achieved by generating the airflows per nozzle row 106 rather than per nozzle 104. Moreover, a substantial increase in the cost for providing the air blowing units 120 can also be prevented. The body of the inkjet printer according to the conventional manufacturing technique can be used. Thus, the increase in the cost can be further suppressed.

In the air blowing unit 120, it is preferable that a structure that forms air passages be detachable from the inkjet head 12 main unit to facilitate cleaning in case of staining by the ink.

As long as all the nozzle rows 106 receive uniform airflow of the same strength, the number of feed ports for the airflows, the structure of the air passage on the nozzle surface, etc., can be suitably changed. For example, by bulkheading the air passage with a barrier in a direction of the airflow, the mechanical strength of the airflow can be increased, and the airflow can be further streamlined.

For the sake of ease of explanation, a structure having only one nozzle row 106 per color has been described above. However, two or more nozzle rows 106 per color can also be provided. By having such a structure, the printing speed and the print resolution can be increased. In such a case, the air blowing unit 120 generates the slit-shaped airflows from areas on either side of a plurality of the adjacent nozzle rows 106.

FIG. 5 is a more detailed drawing of a second example of a structure of the inkjet head 12. (a) in FIG. 5 is a cross-sectional view of the inkjet head 12 and (b) in FIG. 5 is a drawing of the inkjet head 12 viewed from underside (nozzle surface). The inkjet head 12 described in the present embodiment is identical to or similar to the inkjet head 12 explained with reference to FIG. 4 in all respects except the point explained below.

In the present embodiment, the inkjet head 12 has a structure in which the nozzle rows 106 of the nozzles 104, each of which discharges the ink of one color among a plurality of colors being used, are provided as an integrated unit. In this case, the inkjet head 12 includes the nozzle plate 102 in which are formed a plurality of the nozzle rows 106, each of which corresponds to one color. Each of the nozzle rows 106 corresponds, for example, to one of the YMCK inks and the metallic ink or the pearl-colored ink.

Furthermore, in the present example, the inkjet head 12 includes the primary-airflow feed port 112 and the secondary-airflow feed port 114 for the air blowing unit 120 corresponding to the nozzle row 106 for each color. The air blowing unit 120 corresponding to the nozzle row 106 for each color generates the air fed from the primary-airflow feed port 112 and the secondary-airflow feed port 114 each provided at one place. Alternatively, the inkjet head 12 can include a separate primary-airflow feed port 112 and a separate secondary-airflow feed port 114 for each air blowing unit 120 corresponding to the nozzle row 106 for each color.

In the present embodiment, as shown in (b) in FIG. 5, the secondary-airflow blowing port 110 includes a plurality of holes arranged in the second area 204. With this structure, the secondary airflow can be appropriately blown from a wider range. Furthermore, the structure of the secondary-airflow blowing port 110 can be the same as that of the secondary-airflow blowing port 110 in the inkjet head 12 explained with reference to FIG. 4. Furthermore, the structure of the secondary-airflow blowing port 110 shown in FIG. 4 can be the same as that of the secondary-airflow blowing port 110 shown in FIG. 5.

In the present embodiment, the primary airflow and the secondary airflow that assist the flight of the ink droplets is appropriately generated. Thus, the impact of the air resistance encountered by the ink droplets can be appropriately suppressed even if the flight distance is increased by accelerating the ink flow.

Although the present invention has been described with respect to a specific embodiment for a complete and clear disclosure, the appended claims are not to be thus limited, but are to be construed as embodying all modifications and alternative constructions that may occur to one skilled in the art which fairly fall within the basic teaching herein set forth.

### INDUSTRIAL APPLICABILITY

The present invention can be suitably used in inkjet printers.

### EXPLANATIONS OF LETTERS OR NUMERALS

10: Inkjet printer
12: Inkjet head
14: Ink bottle
16: Intermediate ink tank (Ink storage unit)
18: Blower
20: Airflow supply pipe
22: Airflow branch pipe (Pressure adjusting unit)
50: Printing medium
102: Nozzle plate
104: Nozzle
106: Nozzle row
108: Primary-airflow blowing port
110: Secondary-airflow blowing port
112: Primary-airflow feed port
114: Secondary-airflow feed port
120: Air blowing unit
202: First region
204: Second region

1. An inkjet printer comprising an inkjet head that discharges an ink droplet towards a printing medium,
wherein the inkjet head includes
a nozzle that discharges the ink droplet towards the printing medium, and
an air blowing unit that generates an airflow towards the printing medium along the ink droplet discharged from the nozzle,
wherein the air blowing unit includes
a primary-airflow blowing port that generates a primary airflow that is directed towards the printing medium along the ink droplet discharged from the nozzle, and
a secondary-airflow blowing port that generates a secondary airflow that is directed towards the printing medium along the ink droplet on either side of the primary airflow.

2. The inkjet printer according to claim 1, wherein
the nozzle is formed on a nozzle surface that faces the printing medium in the inkjet head,
the primary-airflow blowing port is formed at a position that is adjacent to the nozzle on the nozzle surface, and
the secondary-airflow blowing port is formed at a position that is adjacent to the nozzle on either side of the primary-airflow blowing port on the nozzle surface.

3. The inkjet printer according to claim 2, wherein
the inkjet head includes a plurality of the nozzles arranged in a row as a nozzle row on the nozzle surface,
the primary-airflow blowing port that is provided in a first area that is adjacent to the nozzle row on the nozzle surface, and that extends along a direction of the nozzle row, and the primary-airflow blowing port blows from the first area a slit-shaped primary airflow on either side of the nozzle row, and
the secondary-airflow blowing port that is provided in a second area that is adjacent to the first area on the nozzle surface, and that extends along a direction of the nozzle row, and the secondary-airflow blowing port blows from the second area a slit-shaped secondary airflow towards the printing medium along the primary airflow.

4. The inkjet printer according to claim 1, wherein the secondary-airflow blowing port blows the secondary airflow at a speed that is 0.3 to 1.2 times the speed of the primary airflow.

5. The inkjet printer according to claim 1, wherein the inkjet head discharges the ink droplet from the nozzle at an initial speed that is such that a speed of the ink droplet at a time of deposition on the printing medium is higher than a speed of the main airflow at a time the airflow reaches the printing medium.

6. The inkjet printer according to claim 1, further comprising:
an ink storage unit that stores therein the ink to be discharged from the nozzle; and
a pressure adjusting unit that adjusts an ambient pressure of the ink storage unit,
wherein the pressure adjusting unit adjusts the ambient pressure of the ink storage unit by relaying a blowing pressure of the main airflow from the primary-airflow blowing port to the ink storage unit.

7. An inkjet head that discharges an ink droplet towards a printing medium, the inkjet head comprising:
a nozzle that discharges the ink droplet towards the printing medium; and
an air blowing unit that generates an airflow directed towards the printing medium along the ink droplet that is discharged from the nozzle, wherein
the air blowing unit includes
a primary-airflow blowing port that generates a primary airflow that is directed towards the printing medium along the ink droplet discharged from the nozzle, and
a secondary-airflow blowing port that generates a secondary airflow that is directed towards the printing medium along the ink droplet on either side of the primary airflow.

8. A printing method for printing by an inkjet method by discharging an ink droplet towards a printing medium, the printing method comprising:
discharging the ink droplet from a nozzle towards the printing medium; and
blowing from an air blowing unit an airflow directed towards the printing medium along the ink droplet discharged from the nozzle,
wherein the airflow directed towards the printing medium includes
a primary airflow that is directed towards the printing medium along the ink droplet discharged from the nozzle, and
a secondary airflow that is directed towards the printing medium along the ink droplet on either side of the primary airflow.

9. The inkjet printer according to claim 2, wherein the secondary-airflow blowing port blows the secondary airflow at a speed that is 0.3 to 1.2 times the speed of the primary airflow.

10. The inkjet printer according to claim 3, wherein the secondary-airflow blowing port blows the secondary airflow at a speed that is 0.3 to 1.2 times the speed of the primary airflow.

11. The inkjet printer according to claim 2, wherein the inkjet head discharges the ink droplet from the nozzle at an initial speed that is such that a speed of the ink droplet at a time of deposition on the printing medium is higher than a speed of the main airflow at a time the airflow reaches the printing medium.

12. The inkjet printer according to claim 3, wherein the inkjet head discharges the ink droplet from the nozzle at an initial speed that is such that a speed of the ink droplet at a time of deposition on the printing medium is higher than a speed of the main airflow at a time the airflow reaches the printing medium.

13. The inkjet printer according to claim 2, further comprising:
an ink storage unit that stores therein the ink to be discharged from the nozzle; and
a pressure adjusting unit that adjusts an ambient pressure of the ink storage unit,
wherein the pressure adjusting unit adjusts the ambient pressure of the ink storage unit by relaying a blowing pressure of the main airflow from the primary-airflow blowing port to the ink storage unit.

14. The inkjet printer according to claim 3, further comprising:
an ink storage unit that stores therein the ink to be discharged from the nozzle; and
a pressure adjusting unit that adjusts an ambient pressure of the ink storage unit,
wherein the pressure adjusting unit adjusts the ambient pressure of the ink storage unit by relaying a blowing pressure of the main airflow from the primary-airflow blowing port to the ink storage unit.
